(19) United States
(12) Patent Application Publication
(10) Pub. No.: US 2006/0231787 A1
(43) Pub. Date: Oct. 19, 2006

(54) Tight control device

(76) Inventor: Vincenzo Varriale, Cassina De Pecchi (MI) (IT)

Correspondence Address: AKERMAN SENTERFITT, P.O. BOX 3188, WEST PALM BEACH, FL, 33402-3188, US

(21) Appl. No.: 10/533,042

(22) PCT Filed: Oct. 31, 2003
(86) PCT No.: PCT/EP03/12173

§ 371 Date: Nov. 18, 2005

(30) Foreign Application Priority Data
Oct. 31, 2002 (IT) TO2002A0000943

(51) Int. Cl. F16K 31/44

(52) U.S. Cl. 251/213

(57) ABSTRACT

A tight control device (1) for the transmission of a rotary motion from a primary shaft (3) to a secondary shaft (5), allowing the volume (P) housing the primary shaft (3) to be separated in a tightly manner from the volume (S) housing the secondary shaft (5), said device comprising a couple of sloped parallel rotating plates (7, 11), each one being fixed to a corresponding one of said shafts (3, 5), interconnected by means of oscillating parallel rods (9), articulated to corresponding C-shaped cages (13, 21) arranged around said plates (7, 11), in order to allow said plates (7, 11) to rotate therein.

### TECHNICAL FIELD

The present invention relates to a tight control device.

More particularly, the present invention relates to a device for transmitting a rotary motion, i.e. a torque, from a primary shaft to a secondary rotating shaft ensuring the seal between the volume housing said primary shaft and the volume housing the secondary shaft.

The device according to the invention can be applied to the transmission of a rotary motion from the shaft of a control member, for example a lever or an handwheel, to the stem or ball of a valve for fluids, particularly in plants wherein the process fluid is a toxic, harmful or dangerous fluid.

### BACKGROUND ART

When manufacturing tight rotation control devices the problem of how ensuring in time a convenient seal between the static and dynamic parts is well known, being seals wearing.

The U.S. Pat. No. 5,165,657 relates to an actuator for rotating stem valve wherein a bellow seal ensuring the actuator seal is not twisted. To achieve such a result, a first cam is interposed between the primary shaft and the actuator on which the bellows is mounted and a second cam is interposed between said actuator and the secondary shaft. An axial movement of the actuator, which involves in turn a rotation of the second cam, integral with the secondary shaft, corresponds to a rotation of the first cam, integral with the primary shaft. Therefore, the actuator and the bellows arranged thereon only undergo axial stresses.

Nevertheless, the scheme being described is not suitable to be used in applications wherein a high torque is to be applied. In fact, on these occasions it would be necessary to conveniently size control members and the so-formed device will have dimensions being incompatible with the applications assigned thereto.

### DISCLOSURE OF INVENTION

Main object of the present invention is thus to provide a tight control device capable of supporting high torques.

Moreover, the device being described in the above-mentioned patent is not suitable to be applied to salient stem valves and it requires modifications to be fitted to such a valve, which would make it bulky and expensive. Other solutions being provided up to now have similar drawbacks. For this reason, in the field of salient stem valves the use of sealing bellows is limited to the cases in which it is strictly indispensable (poisonous or very toxic line fluids) and it is not implemented in cases in which it would be however recommended.

Another object of the present invention is thus to provide a reduced-dimension tight control device which can be used for implementing any type of valve for fluids, both rotating stem and salient stem valves.

These and other objects are achieved by the control device according to the present invention, as claimed in the appended claims.

The device according to the invention uses a couple of parallel oscillating plates, commonly known as “swash plates”, allowing a rotary motion to be turned into an alternate translatory motion and vice versa.

In the device according to the invention, bellows and rods comprised therein only undergo an axial stress and not a torque.

Advantageously, the load transmitted is equally distributed between all the rods, with subsequent considerable advantages on the size of the rods themselves, which can have a diameter section comparable to the section of the rotating shafts and of the bellows associated thereto.

It should be noted that the uniform load distribution is allowed by the fact that, at each primary shaft rotation, all the rods operate simultaneously, some in traction, the others in compression, according to the respective angular position of the plates.

The load distribution between several rods allows, inter alia, smaller bellows to be used, having less thick walls and higher life.

In the case of rotating stem valves, the so-called quarter-turn valves (ball, throttle, plug valves), the secondary shaft can coincide directly with the valve stem. In the case of salient stem valves (globe, gate valves), the secondary shaft can be hollow and internally thread and it can serve as nut thread for the valve threaded stem, so that a rising/descending movement of said stem corresponds to a rotation of the secondary shaft. Advantageously, given the device reduced dimension, several partitions and bellows arranged in series on the rods can be used, thus obtaining a redundant sealing system. In particular, by using two partitions, each one with its own series of bellows, it is possible to create an insulated chamber both from the external environment and from the process line. Said chamber can be advantageously connected to a leak detector indicating possible seal losses of the device.

Some preferred embodiments of the control device according to the invention, given by way of non limiting example, will now be described in detail with reference to the attached drawings, wherein:

### BRIEF DESCRIPTION OF DRAWINGS

FIG. 1 is a longitudinal section of the tight control device according to a first embodiment of the invention;

FIG. 2 shows a detail of the device of FIG. 1;

FIG. 3 shows a detail of the device of FIG. 1 in an alternative embodiment;

FIG. 4 is a schematic longitudinal section of a second embodiment of the invention;

FIG. 5 is a schematic longitudinal section of a third embodiment of the invention.

### MODES FOR CARRYING OUT THE INVENTION

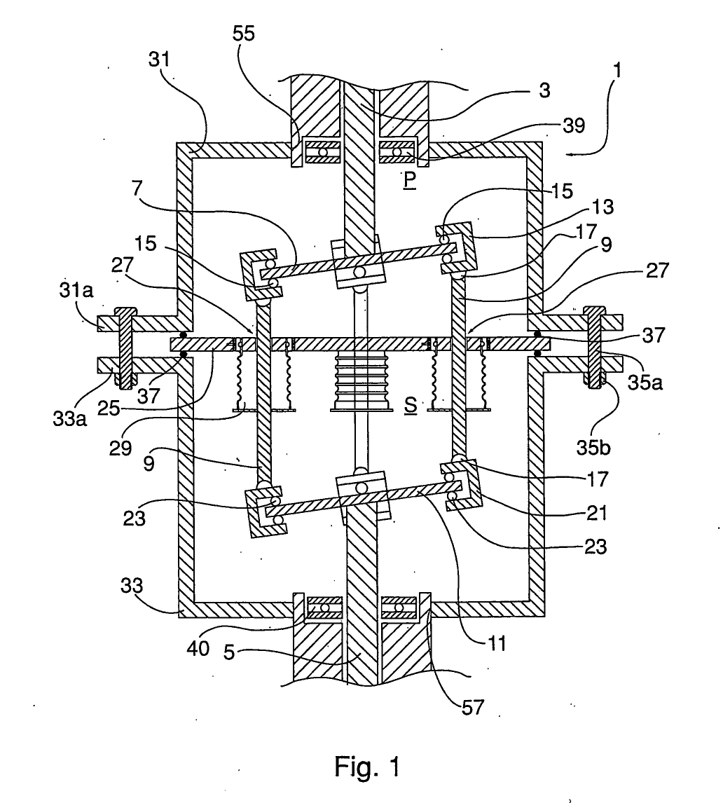

With reference to FIG. 1 a tight control device according to the invention is globally indicated with 1, through which the rotary motion imparted to a primary shaft 3, for example by means of an handwheel or a level (not shown), can be transmitted to a rotating secondary shaft 5, separated in a tightly manner from said primary shaft 3 and substantially coaxial therewith.

According to the invention, an end of the primary shaft 3 is fixed in the middle of a primary circular plate 7, slopingly arranged with respect to shaft 3. A series of “C”-section cages 13 is arranged at the periphery of the primary plate 7, wherein the plate 7 can rotate, by means of balls and rollers 15, interposed between said cages 13 and both surfaces of the plate 7.

Similarly, an end of the secondary shaft 5 is fixed in the middle of a secondary circular plate 11, slopingly arranged with respect to shaft 5 in order to be parallel to the primary plate 7.

A series of “C”-section cages 21 is arranged at the periphery of the secondary plate 11, wherein the plate 11 can rotate, by means of balls and rollers 23 interposed between said cages 21 and both surfaces of the plate 11.

The cages 13 of the primary plate 7 and the cages 21 of the secondary plate 11 are interconnected by means of a plurality of parallel rods 9, connected by means of articulations or hinges 17 to the corresponding cages 13 and 21. It should be noted that, since cages can oscillate with respect to plates, said hinges or articulations can be unnecessary if the plates are not very sloping.

The configuration shown allows the secondary shaft 5 to be rotated by rotating the primary shaft 3. The motion transmission between the primary shaft 3 and the secondary shaft 5 occurs by means of the oscillation of cages 13 and 21 and, consequently, of parallel rods 9, caused by the rotation of the sloping plate 7, helped by the rotation of the secondary plate 11.

The control device according to the invention provides also a partition 25 through which the volume P wherein the primary shaft 3 and the primary plate 7 operate is separated from the volume S wherein the secondary shaft 5 and the secondary plate 11 are housed.

Said partition 25 is provided with a series of holes 27 for rods 9 to pass, it is arranged substantially perpendicularly to said rods 9 and it allows said rods to be guided in their axial motion, preventing the revolution thereof around the axis of the primary 3 and secondary 5 shafts. According to the invention, said rods 9 are the only control device member passing through both volumes P and S separated by the partition 25.

Rods 9 are also partially enclosed in corresponding sealing sleeves or bellows 29 which have an end tightly fixed to the partition 25 around each hole 27 and the opposite end tightly closed around the corresponding rod 9. Therefore the seal between the primary volume P and the secondary volume S is ensured.

As can be seen in FIG. 1, advantageously the sleeves 29 are always compressed from outside due to the pressure of the fluid process contained in the secondary volume S.

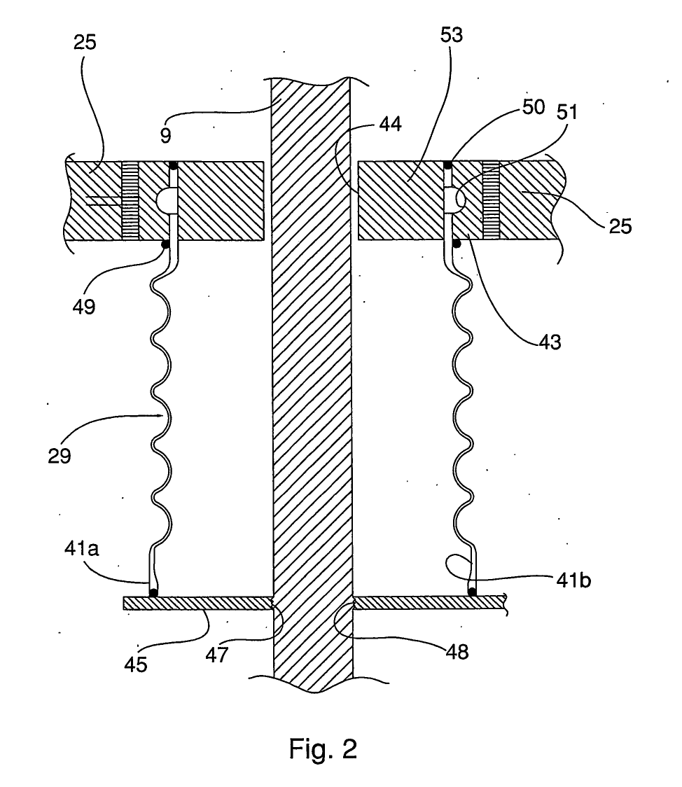

As it can be better seen in FIG. 2, sleeves 29 comprise a cylindrical body 41, preferably multilayer, having a corrugated profile obtained, for example, through pot die.

Sleeves 29 are fixed to the partition 25 in correspondence with holes 27 by means of an outer ring 43 whereto the outer wall 41a of the sleeve 29 is fixed, for example through welding, in 49. The inner wall 41b of the sleeve 29 is fixed, for example through welding, in 50 to an inner ring 53 and to the outer ring 43.

The outer ring 43 preferably comprises an annular channel 51 wherein the gas eventually existing between the two walls 41a and 41b of the sleeve 29 flows, further to a leakage cause by the cracking of the outer wall 41a.

In the preferred multilayer seal case, vacuum conditions can also be created between the different layers and the channel 51 can be connected to a pressure detector which serves thus as leak detector.

The inner ring 53 has a central hole 44 through which the corresponding rod 9 is guided.

The opposite end of the sleeve 29 is fixed, for example through welding, to a circular disc 45 being centrally drilled in 47 to let the corresponding rod 9 pass. The central hole 47 of the disc 45 is preferably internally threaded, as well as the portion 48 of rod 9 in correspondence with said disc 45. The disc 45 can therefore be screwed and sealed on the rod 9 to prevent gas from flowing between the rod 9 and the disc 45.

According to the described configuration, the oscillating or “up and down” motion of rods 9 is helped by the axial motion of the disc 45 which, by moving axially, causes the deformation of the sleeve 29.

Advantageously, according to the invention, it is possible to control a rotating secondary member, for example a valve for fluids, ensuring an efficient seal between the environment wherein the valve is located and the environment wherein the primary control member is located.

Advantageously, the axial load is uniformly distributed on all the rods 9, which operate simultaneously, some in traction, the others in compression, according to the angular position of plates 7 and 11 and to the direction of rotation thereof.

In order to avoid tripping problems and keep the uniform angular distribution of rods 9 which ensures the homogeneous distribution of stresses, the number of said rods 9 should be preferably odd, for example five or seven.

Returning to FIG. 1, the device according to the invention is advantageously enclosed in an envelope composed of two detachable parts 31 and 33 surrounding device 1 members and allowing the primary shaft 3 and the secondary shaft 5 to pass through corresponding holes 55 and 57 housing corresponding bearings 39 and 40. Said bearings 39 and 40 will preferably be conical in order to play also the role of thrust bearing. It should be noted that, alternatively, said bearings could also be provided in correspondence with the partition.

The two parts 31 and 33 of the envelope are coupled to each other along respective L-bent peripheral edges 31a and 33a urged the one against the other by means of a plurality of bolts 35a and nuts 35b.

A peripheral portion of the partition 25, which is tightly locked between said edges by means of a couple of annular gaskets 37 is advantageously housed between said peripheral edges 31a and 33a of the two parts 31 and 33 of the envelope.

Alternatively, it is also possible to provide that the union between the partition 25 and said peripheral edges 31a, 33a is obtained through welding.

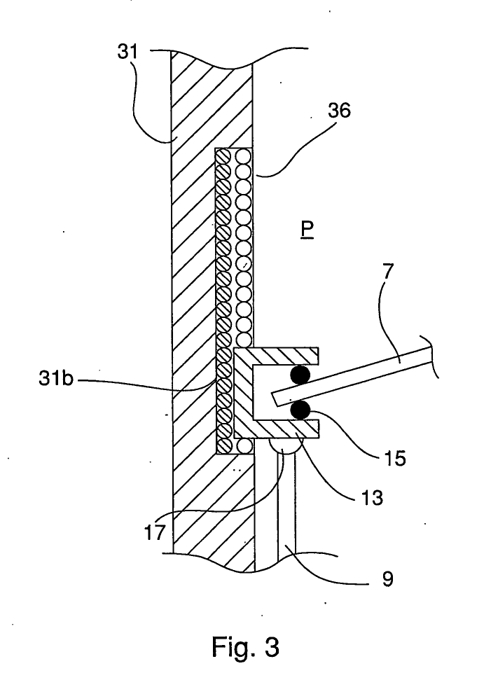

FIG. 3 relates to an alternative of the embodiment being described, ensuring that rods 9 and sleeves 29 associated thereto always undergo a purely axial stress.

In fact, in the configuration being described the partition 25 plays the role of a guide for rods 9 during the plate rotation; said rods 9 will therefore undergo a transverse stress caused by the fact that they are guided through the partition 25, in correspondence with holes 27. This transverse stress can have the consequence of causing a flexion of rods 9.

In order to overcome this drawback, instead of guiding directly rods 9 in their oscillating motion, it is possible to guide the cages 13, 21 whereto said rods 9 are hinged.

To this purpose, it is possible to provide the housing and sliding of the cages 13, 21 of the primary and secondary plates 7, 11 in convenient grooves created in the inner walls of the outer envelope of the device 1.

Always with reference to FIG. 3, the inner wall of the part 31 of said envelope is equipped with axial grooves 31b, in which a corresponding cage 13 is housed. Cages 13 slide in said grooves 31b in the oscillating “up and down” motion induced by the rotation of the plate 7 sliding on convenient guides equipped with balls 36.

Said balls could also be replaced by sliding inserts formed with suitable materials to limit the leaks by friction.

A similar configuration is used for the cages 21 of the secondary plate 11.

Advantageously, this configuration involves a negligible load loss by friction and it allows the formation of bending stresses on rods 9 to be avoided.

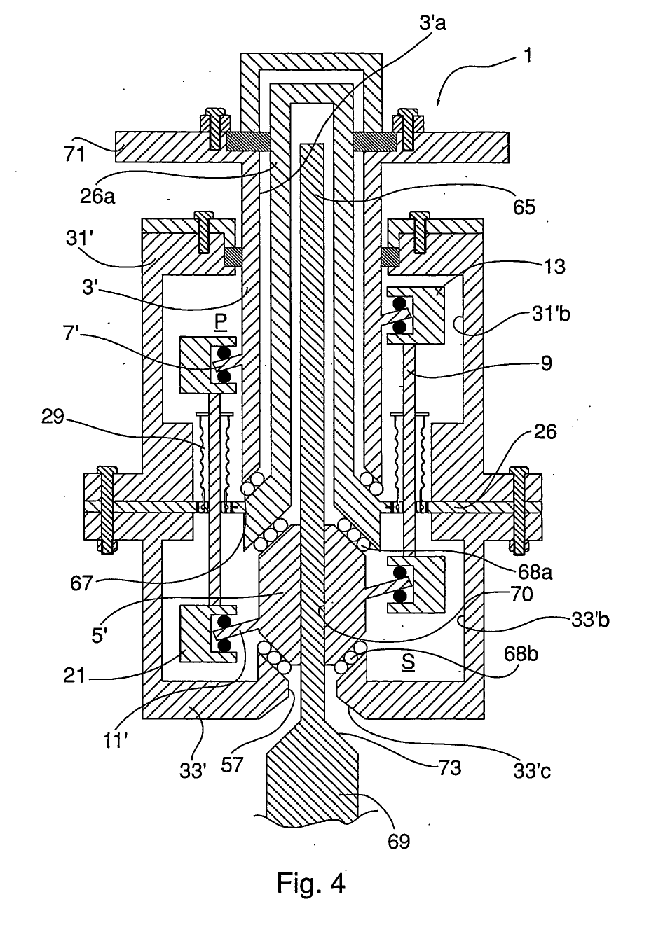

FIG. 4 is a second embodiment of the invention, particularly suitable for applications to salient stem valves.

In the case of salient stem valves, the control system generally has a higher axial dimension since it must comprise a screw-nut screw system to turn the rotary motion of the secondary shaft in a rising/descending motion of the valve stem.

To limit the device axial development in applications to salient stem valves, it is possible to use the embodiment of FIG. 4, according to which the valve stem 65 is housed in the device 1.

In this embodiment, the partition 26 has a housing 26a wherein the valve stem 65 can slide in its rising/descending motion.

The primary shaft 3′, integral with an handwheel 71, has a corresponding cavity 3′a housing said housing 26a wherein said stem 65 is housed.

Also in this case, the tight separation between the volume P of the primary shaft 3′ and the volume S of the secondary shaft 5′ is ensured by the partition 26 and the sleeves 29 arranged on the rods 9.

In this second embodiment of the invention, the sloped plate 7′ associated to the primary shaft 3′ is crossed by the shaft 3′. Said shaft 3′ extends up to the partition 26 in correspondence therewith a thrust bearing 67 is provided.

The secondary shaft 5′ is provided in turn with a threaded hole 70 wherein the valve threaded stem 65 is engaged. Therefore a screw-nut screw system is formed, which allows the rotary motion of the shaft 5′ to be turned into a translatory motion of the stem 65, allowing thus the valve to be opened and closed.

Said housing 26a will thus have a sufficient length to comprise the threaded portion of the stem 65 in order to allow the valve to be completely opened.

Thrust bearings, respectively 68a and 68b, are also provided between said shaft 5′ and said partition 26 and between said shaft 5′ and the envelope part 33′.

Similarly to the primary plate 7′, also the secondary plate 11′ is crossed by the secondary shaft 5′.

Cages 13, 21 slide in convenient grooves 31′b, 33′b created in the two envelope parts 31′, 33′ of the device 1. Moreover, being the plates 7′, 11′ not very sloped, hinges between the cages 13, 21 and the rods 9 are not provided.

Advantageously, because of the fact that the stem 65 is completely comprised in the housing 26a, it is not necessary to provide a gas tightness in correspondence with said stem. Therefore, the stem 65 could be completely threaded and the length thereof limited to the useful part to control the valve opening, with a subsequent dimension reduction.

It should be also noted that, in correspondence with the hole 57 provided for the stem 65 to pass through the envelope part 33′ a conical abutment 33′c is provided, which engages tightly with the valve shutter 69 which has in turn a corresponding conical abutment 73. Therefore, bringing the stem 65 in the valve complete opening position, it is possible to form a seal between said envelope part 33′ and said shutter 69, in order to replace possible damaged elements of the device 1 without risk of leaks.

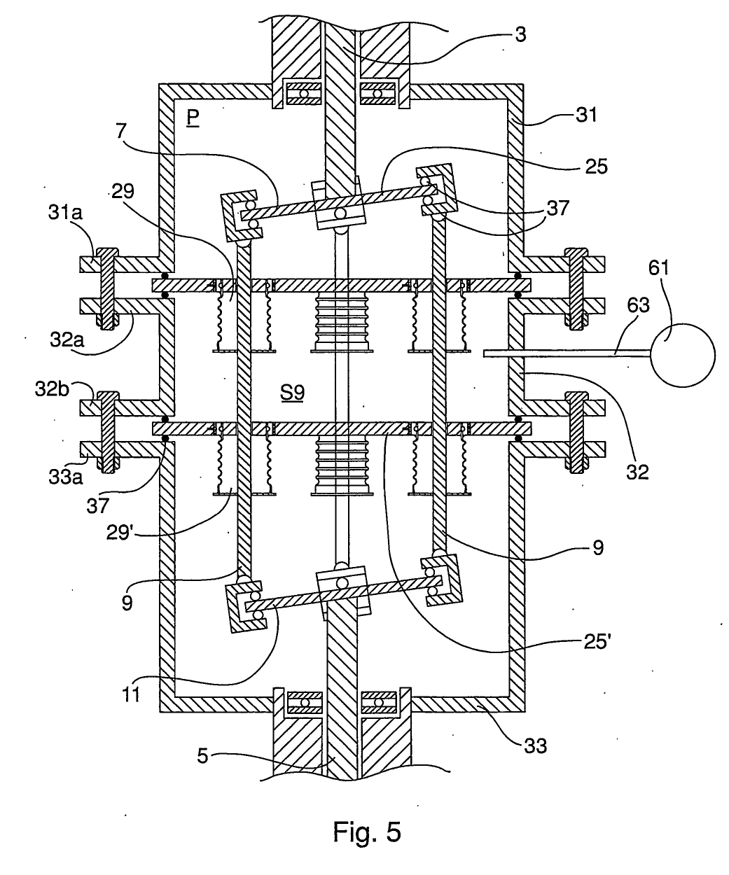

FIG. 5 is a further embodiment of the device according to the invention, wherein a seal redundancy is provided, in order to further ensure the device seal.

According to this embodiment of the invention, a second partition 25′ is provided, which is parallel to the first partition 25 and provided with a corresponding series of sealing sleeves 29′.

Always according this embodiment of the invention, the envelope enclosing the device has a ring-shaped intermediate part 32 equipped at the periphery thereof with bent edges 32a and 32b coupling with respective edges 31a and 33a of the envelope parts 31 and 33 locking tightly between them the partition 25 and the partition 25′ through corresponding gaskets 37.

According to this embodiment of the invention two barriers, instead of one, are advantageously interposed between the primary volume P and the secondary volume S.

Moreover, a chamber 59 being tightly insulated from both volumes P and S is defined between the two partitions 25 and 25′.

Advantageously, said chamber 59 can be used to timely locate possible gas leaks, through a convenient detector 61 in communication, by means of a duct 63, with the chamber 59.

This alternative embodiment allows several partitions 25, 25′ to be overlapped, each one associated to corresponding sealing sleeves 29, 29′ for rods 9, keeping the device overall dimensions within acceptable limits.

It should also be noted that it is possible to provide that sealing sleeves 29, 29′ are both arranged in the intermediate chamber 59. In this case sleeves 29, 29′ of the same rod 9 could also be partially overlapped in order to limit the distance between the two partitions and, consequently, the device dimension.

The device being described allows the predetermined objects to be achieved, since it allows a rotary motion to be transmitted from a primary shaft to a secondary shaft, ensuring a tight separation. The presence of a plurality of rods, among which the load is uniformly distributed, allows the transmission device dimension to be reduced and said device to be used also in case of transmission of high torques.

1. A tight control device comprising:
a rotating primary shaft;
a rotating secondary shaft being coaxial to said primary shaft;
a first circular plate slopingly fixed to said primary shaft;
a second circular plate fixed to said secondary shaft and parallel to said first plate;
a first plurality of cages circumferentially arranged around said first plate and relative to which said first plate can rotate and a second plurality of cages circumferentially around said second plate and relative to which said second plate can rotate, each of said first cages being interconnected to a corresponding one of said second cages by means of an oscillating rod which is parallel to said shafts, hinged to said cages;
a partition between said sloping plates provided with holes through which said oscillating rods pass;
a sealing sleeve arranged around each of said oscillating rods in correspondence with said holes to prevent gas from flowing through said holes during the oscillating motion of said oscillating rods imparted by the rotation of said first plate caused by the rotation of said primary shaft, said oscillating motion being transmitted to said second cages to cause the rotation of said second plate and, consequently, of said secondary shaft.

2. The tight control device of claim 1, wherein said sleeves have an end being tightly fixed to the partition around each hole and the opposite end being tightly closed around the corresponding oscillating rod.

3. The tight control device of claim 2, wherein the sleeves comprise a multilayer cylindrical body provided with an outer wall and an inner wall and having a corrugated profile.

4. The tight control device of claim 3, wherein the sleeves are fixed to the partition in correspondence with holes by means of an outer ring whereto both the outer wall and the inner wall of the sleeve are fixed.

5. The tight control device of claim 4, wherein the outer ring comprises an annular channel wherein the gas eventually existing between the two walls of the sleeve flows, further to a leakage caused by the cracking of the outer or inner wall.

6. The tight control device of claim 5, wherein vacuum is achieved between said outer and inner walls of said multilayer sleeve and wherein said annular channel is in communication with a pressure detector.

7. The tight control device of claim 4, wherein an inner ring is provided, which is concentric to said outer ring and tightly fixed thereto, though which the oscillated rod is guided.

8. The tight control device of claim 2, wherein the opposite end of the sleeve is fixed to a circular disc centrally drilled to allow the corresponding oscillating rod to pass, said disc being tightly fixed to the oscillating rod.

9. The tight control device of claim 8, wherein said central hole in said disc is internally threaded as well as the portion of oscillating rod in correspondence with said disc, said oscillating rod engaging said thread in order to ensure the seal between said disc and said oscillating rod.

10. The tight control device of claim 1, wherein corresponding balls or rollers are interposed between said first cages and said first plate and between said second cages and said second plate.

11. The tight control device of claim 1, wherein a second partition is provided, being substantially parallel to the first partition, and provided with a corresponding series of sleeves.

12. The tight control device of claim 1, wherein an envelope is provided, which is composed of at least two detachable parts surrounding the device members and allowing the primary shaft and/or the secondary shaft to go outward through corresponding holes housing respective bearings.

13. The tight control device of claim 12, wherein said at least two parts of the envelope are coupled to each other along respective L-bent peripheral edges closed the one against the other by means of a plurality of bolts and nuts, a peripheral portion of the partition, which is tightly locked between said edges by means of seals, being housed between said peripheral edges of the two parts of the envelope.

14. The tight control device of claim 1, wherein a second partition is provided, being substantially parallel to the first partition, and provided with a corresponding series of sleeves, an envelope is provided, which is composed of at least two detachable parts surrounding the device members and allowing the primary shaft and/or the secondary shaft to go outward through corresponding holes housing respective bearings and wherein an envelope intermediate part is provided between said at least two parts of the envelope and wherein said two parts are coupled to said intermediate part along respective L-bent peripheral edges closed against corresponding L-bent edges of the envelope intermediate part by means of a plurality of bolts and nuts, a peripheral portion of said first partition and of said second partition respectively being housed between said peripheral edges of the two parts and of the envelope intermediate part, the seal between said portions and said edges being ensured by corresponding seals.

15. The tight control device of claim 14, wherein a tightly insulated chamber is defined between said two partitions and wherein a pressure detector in communication with said chamber is provided in order to timely indicate possible pressure variations therein caused by leaks through sealing sleeves.

16. The tight control device of claim 15, wherein for each of said oscillating rods the corresponding sealing sleeves are both arranged in said intermediate chamber.

17. The tight control device of claim 16, wherein said sealing sleeves corresponding to the same oscillating rod partially overlap on each other.

18. The tight control device of claim 12, wherein the inner part of said envelope comprises axial straight grooves in which said cages are slidingly housed.

19. The tight control device of claim 1 wherein said partition comprises a housing wherein an axially sliding control rod is housed, said housing being arranged concentrically in said primary shaft.

20. The tight control device of claim 19, wherein said control rod is the threaded control rod of a salient valve for fluids and wherein said secondary shaft is drilled and internally threaded to engage with said control rod.

21. The tight control device of claim 20, wherein said sloped plates are respectively crossed by said primary and secondary shaft.

22. The tight control device of claim 21, wherein said secondary shaft is completely housed in the device envelope, and wherein said secondary shaft is hold between two thrust bearings mounted, respectively, in correspondence with said partition and said envelope.

23. The tight control device of claim 1, wherein said oscillating rods are odd in number.

24. The tight control device of claim 1, wherein said first cages and said second cages are uniformly spread around the corresponding sloped plate.

25. A valve for fluids characterised in that it comprises a tight control device including:
a rotating primary shaft;
a rotating secondary shaft being coaxial to said primary shaft;
a first circular plate slopingly fixed to said primary;
a second circular plate fixed to said secondary shaft and parallel to said first plate;
a first plurality of cages circumferentially arranged around said first plate and relative to which said first plate can rotate and a second plurality of cages circumferentially around said second plate and relative to which said second plate can rotate, each of said first cages being interconnected to a corresponding one of said second cages by means of an oscillating rod which is parallel to said shafts, hinged to said cages;
a partition between said sloping plates provided with holes through which said oscillating rods pass;
a sealing sleeve arranged around each of said oscillating rods in correspondence with said holes to prevent gas from flowing through said holes during the oscillating motion of said oscillating rods imparted by the rotation of said first plate caused by the rotation of said primary shaft, said oscillating motion being transmitted to said second cages to cause the rotation of said second plate and, consequently, of said secondary shaft.

26. The valve for fluids of claim 25, wherein said valve is a ball, or throttle, or plug or globe or gate valve.
